(19) United States
(12) Patent Application Publication
(10) Pub. No.: US 2020/0311065 A1
(43) Pub. Date: Oct. 1, 2020

(54) Virtual De-Normalization

(71) Applicant: Michael Wayne Martin, Ocean Isle Beach, NC (US)

(72) Inventor: Michael Wayne Martin, Ocean Isle Beach, NC (US)

(21) Appl. No.: 16/900,831

(22) Filed: Jun. 12, 2020

Related U.S. Application Data
(63) Continuation-in-part of application No. 14/936,742, filed on Nov. 10, 2015.

(51) Int. Cl. G06F 16/2453; G06F 16/22; G06F 16/2458

(52) U.S. Cl. CPC G06F 16/2453; G06F 16/2471; G06F 16/22

(57) ABSTRACT

This document discloses a software, data structure, method, apparatus and article of manufacture that allows database engines to implement tables that simultaneously exhibit the advantages of both normalization and de-normalization. Examples of such advantages include no data replication or minimum data replication, no table joins or a minimum number of joins, the ability to update data in one place and one place only, and query performance comparable to the same queries on heavily or fully de-normalized tables.

### BACKGROUND OF THE INVENTION

### Technical Field

The present invention relates to OLAP (On-Line Analytical Processing) and DW (Data Warehouse) applications, hereafter referred to as the DW. Specifically, it relates to the design of structured or semi-structured database tables and underlying internal data structures in the database to support the DW in a flexible, performant, and efficient manner.

### Description of Prior Art

DW applications have highlighted the need for fast and efficient methods to store, maintain, and query both large and complex data to support analytic applications.

One of the most important design decisions for any DW relates to the level of normalization in the design and structure of the database tables in the DW. This design decision forces trade offs between flexibility, storage space, agility, maintenance costs, update performance, and query speed. As a result, good DW designs need to balance these trade-offs, preventing optimal performance in any one area such as query speed. Despite the conventional need for a balanced approach, DW designs span a wide spectrum from completely de-normalized to fully normalized.

On one extreme, the approach is to fully de-normalize DW tables up to the point that the structure of each table contains a superset of the data required for each report or query to be extracted from the DW. This provides maximum query speed and ease of use for the specific use cases for which it was designed. However, the existence of a de-normalized table to match every query and report clearly increases storage requirements and the time to update the data. If normalized tables are completely replaced by de-normalized tables, this technique can also fail to preserve important business rules embedded in the data and its associated relationships. Less obviously, it reduces agility and the capability for the designers of the DW to adapt the database design for new data and new use cases. In some cases, too much normalization can even hamper query speed by increasing Input/Output (I/O) operations and processing time to filter out unneeded data.

On the other extreme, the approach is to fully normalize the DW design. This approach is close to the technique advocated by Bill Inmon, albeit Inmon does recognize the need for some de-normalizaton in addition to a foundation of normalized tables. This approach provides maximum flexibility, accurate preservation of business rules, agility, and update speed. It also minimizes storage costs. Its weakness, however, is query speed, query efficiency, and ease of use. Depending on underlying hardware and software such as Massively Parallel Processing (MPP) or in-memory technology, the approach can also provide acceptable query performance. But, even in this case the cost of underlying hardware is expensive and thus inefficient. This inefficiency is further magnified when a large number of users are attempting to run reports and queries simultaneously.

The dimensional design approach, made popular by Ralph Kimball, is a balance of the two extremes. This approach, minimizes redundant primary key to foreign key relationships between data elements, concentrates the source of primary keys for foreign key relationships in dimensions, and limits de-normalization to dimensions and aggregates of fact tables. In general, dimensional designs and aggregations are the preferred approach to balance between normalization and de-normalization for DW applications. When applied with expert knowledge and a good understanding of business requirements, this technique provides a good balance of query performance, agility, and update performance. Nonetheless, due to optimizer instability, overhead in software layers, and the ultimate unpredictability of analytic queries, this technique commonly exhibits problems with query performance and query efficiency. Furthermore, overuse of aggregates reduces agility. And, despite the natural ease of use associated with dimensional database designs, too much normalization can produce hard to use and overly complex dimensional designs with too much “snow flaking”.

A few attempts have been made to balance trade-offs between normalization and denormalization with internal data structures and algorithms. While these techniques operate below the use interface or SQL level, they generally involve some type of data replication. A specific example is join or aggregate indexes. With join or aggregate indexes, the underlying data structures are automatically updated as the underlying tables are updated. When queries are run against the underlying tables, they are redirected to the join or aggregate indexes. This allows queries to execute in a performant and efficient manner. From an update perspective, data must still be replicated and maintained in multiple locations. Therefore, the net result of this technique is the same as classic de-normalization with most the same trade-offs. This technique simply automates the process.

A technique that allows the update efficiency, update performance, flexibility, business rule preservation, and agility of a normalized data model along with the query efficiency, query performance, and ease of use of a de-normalized data is indicated.

### SUMMARY OF OBJECTS AND ADVANTAGES

Objects and advantages that follow do not limit the scope of the present invention in any way. The claims alone should determine the scope of the present invention.

As the below embodiments detail, the present invention provides a method and apparatus that simultaneously provides all the advantages and efficiency of both normalized and denormalized data.

One object and advantage of virtual de-normalization allows DW applications to query data without the need to join multiple tables together. This provides query performance and efficiency as well as ease of use.

A second object and advantage of virtual de-normalization allows normalized data objects to be accessed directly for update efficiency and full preservation of business rules. This provides less expensive maintenance of data and a more accurate representation of the business model that the data supports.

A third object and advantage of virtual de-normalization allows DW applications to be stored with minimum or no replication without sacrificing query performance, query efficiency, or ease of use.

An additional object and advantage of virtual de-normalization makes it immune to the instability of query optimizers in determining query execution paths for each query variation. Virtual de-normalization implements views of the data combining data from more than one normalized table as internal processes and data structures within the database engine where it can enforce more control, efficiency, and stability. The execution path for the single view of multiple tables is the same for all queries that access it, thus eliminating the need to create an optimizer plan for each query.

Another object and advantage of virtual de-normalization allows DW applications to practically perform update operations directly on de-normalized views of the data since interrelationships between the data elements can be efficiently controlled and maintained below the user interface or SQL layer of the database engine.

Yet another object and advantage of virtual de-normalization allows it to efficiently support NoSQL databases that implement the concept of virtual columns or attributes. This allows the same NoSQL table construct to support both normalized and denormalized versions of the same data.

### BRIEF DESCRIPTION OF THE DRAWINGS

FIG. 1 illustrates a normalized product dimension with the two levels of Products and Categories.

FIG. 2 illustrates a normalized date dimension with the four levels of Weeks, Months, Quarters, and Years.

FIG. 3 illustrates a normalized fact table, Tool Sales, with foreign keys for the dimensions of Products and Weeks.

FIG. 4 illustrates a de-normalized fact table, Tool Sales, with the complete product and date dimensions included.

FIG. 5 illustrates a single computer with a hierarchy of storage mediums consisting of arrays of auxiliary memory, RAM, and processor caches capable of housing virtually denormalized data. This architecture implements a shared memory parallel DW platform.

FIG. 6 illustrates an array of interconnected computers, containing hierarchies of storage mediums consisting of arrays of auxiliary memory, RAM, and processor caches capable of housing virtually de-normalized data. This architecture implements a no-share parallel DW platform.

### DETAILED DESCRIPTION OF THE INVENTION

Detailed descriptions, example embodiments, and drawing figures below do not limit the scope of the present invention in any way. The claims alone should determine the scope of the present invention.

Overview

Virtual de-normalization allows database tables to be designed and implemented both as normalized and de-normalized schemas. The normalized schemas are physically stored and implemented. The de-normalized schemas are virtually stored and materialized dynamically when queries or updates are executed. Unlike classic database views, virtual de-normalization is implemented below the user interface or SQL level and need not depend on database optimizers or query implementation software to determine execution paths.

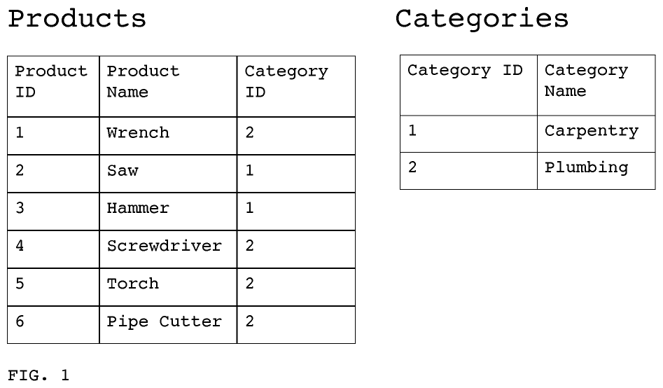

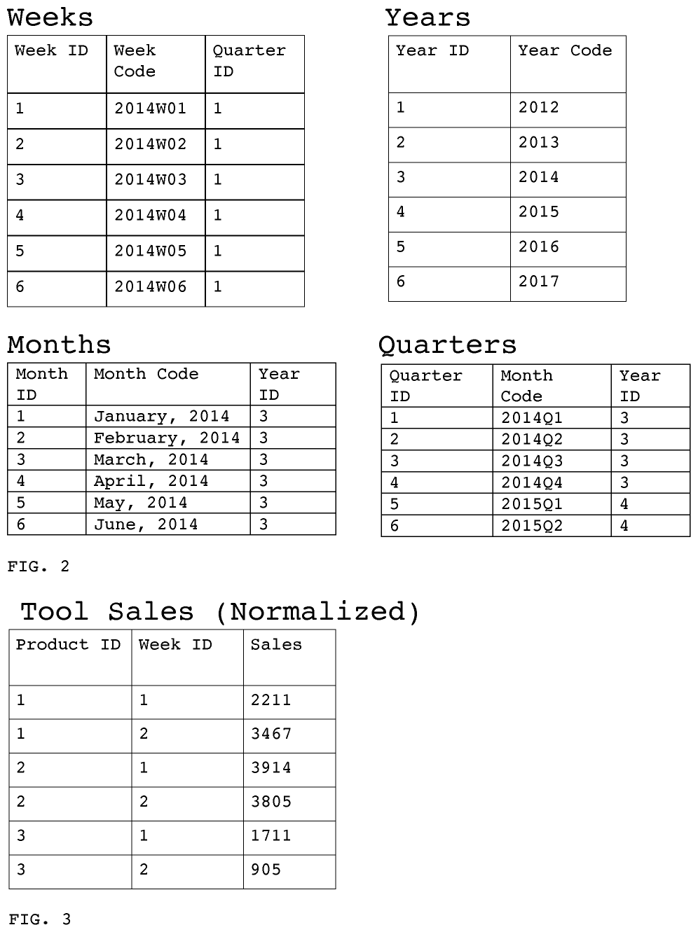

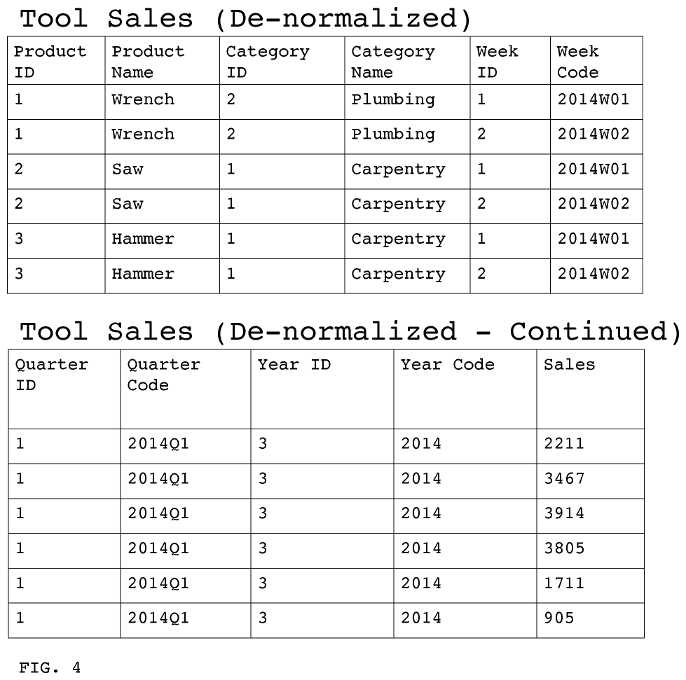

With virtual de-normalization, the DW designer creates the underlying normalized tables as represented by the examples in FIG. 1, FIG. 2, and FIG. 3. In addition to these tables, the DW designer also creates virtually de-normalized tables as represented by the example in FIG. 4. These virtual tables are logically very similar to views in classic relational databases. Whereas classic views are implemented at the user interface or SQL level and executed through the database optimizer, virtually de-normalized tables are implemented internally without the optimizer or query implementation software and therefore are much more performant and efficient. In this scenario, predetermined join paths and index strategies are implemented in the internals of the database to dynamically materialize the virtually de-normalized tables for queries and updates. Finally, this approach is also very stable and reliable since the optimizer or query implementation software does not determine them when a query is designed or executed. The execution strategy and paths are preset for all subsequent queries when the virtually de-normalized table is created, rather than created on a query by query basis.

Operation

With virtual de-normalization, operations on underlying normalized tables are no different than conventional databases. Tables are queried and updated in a standard way through the user or SQL interface and executed via the optimizer. The operations on virtually de-normalized tables are slightly different.

When DW queries access virtually de-normalized tables, the database engine utilizes preset, internal data structures and algorithms to dynamically materialize the denormalized view of the data by joining and optionally filtering one or more underlying normalized tables.

When DW updates execute against virtually de-normalized tables, the database engine utilizes internal join paths and indexes to redirect the update operations to the correct normalized tables. In addition to updating the underlying data via the virtually denormalized tables, update operations can access the normalized tables directly.

### Example Embodiments

The descriptions and example embodiments contained herein illustrate that virtual de-normalization provides a more efficient, software method, data structures, algorithms, apparatuses, and articles of manufacture for dynamically rendering normalized data as efficiently as if it were de-normalized or materialized, but without the associated space and preprocessing costs.

Example embodiments contained herein serve to demonstrate the plausibility and feasibility of this invention, but these embodiments only present examples and do not in any way limit the scope of the present invention. The claims alone should be used to determine the scope of the present invention.

In one embodiment involving single monolithic computers with sufficiently large shared memory or RAM that is equally accessible from all processors and relatively small lookup or dimension tables to be joined to larger tables, all such lookup or dimension tables can be stored in the shared memory or RAM of the monolithic computer via hashing or direct memory location addressing so that the larger table can be joined to the smaller lookup or dimension tables very quickly. Skilled practitioners in the art will recognize that de-normalized or pre-joined and materialized versions of the aforementioned larger tables containing replicated data from all relative lookups and dimensions, in addition to their own core and normalized columns, are likely to require longer execution times for queries due to the increased amount of I/O that is required to scan the much larger, de-normalized table. This is a case where normalized tables joined together dynamically with lookup or dimension tables stored in memory are faster than a single de-normalized version of the same data. In this embodiment virtually de-normalized tables can be defined that dynamically and efficiently join the larger tables to the smaller lookup or dimension tables irrespective of any subsequent queries that are submitted against the virtually de-normalized tables.

This embodiment, however, can be hampered by limited or distributed memory that is not shared by all processors, such as in a distributed computing, no-share parallel computing platforms, or smaller servers with less RAM. In such a scenario, I/O secondary storage or remote calls across networks are required to join the tables. These I/O or network calls can make dynamic de-normalization or joins significantly more expensive than materialized and de-normalized tables.

In another embodiment to make I/O and network calls more efficient, data in tables to be joined can be ordered or sorted according to common key orders. In the case where one or more tables contain more than one foreign key from the other tables, the tables containing more than one foreign key can be ordered or sorted by a combination of all the foreign keys. To maximize efficiency, all the common keys between the tables to be joined should have the same precedence order for sorting such that if a given key has a higher precedence than all the other common join keys, it should have the first order precedence in all tables to be joined where it exists. To further increase performance and efficiency, this sort order can be maintained in a clustered index that is defined on the keys that determine the sort order. As the tables are joined together the common sort orders allows for very efficient match-merge algorithms with minimum I/O to secondary storage or minimum network calls in distributed computing environments. A skilled practitioner in the art will recognize that such a dynamic and efficient match-merge algorithm coupled with pre-sorted data can be more efficient in terms of I/O or network calls than materializing or de-normalizing all the tables into one larger de-normalized table with many columns and large quantities of redundant data where significantly more I/O is required. In this embodiment virtually de-normalized tables can be defined that dynamically and efficiently joins tables with the pre-sorted data and match-merge algorithms.

This embodiment, however, can be hampered by the need to access the tables to be joined by keys or combinations of keys that do not have high precedence in the sort order. Even with the addition of secondary indexes, such non-primary key access can be inefficient due to the increased amount of I/O or network calls that are required.

In another embodiment, multidimensional clustering or partitioning can be utilized for larger tables with multiple keys or dimensions that require access from multiple combinations of alternative keys with varying precedence key orders. In this embodiment, match-merge algorithms can be used across large tables that can't be contained in memory or one processing server in a network of computers from any combination of the join keys that are shared by the tables to be joined. This embodiment works especially well when data is designed in a star-schema or dimensional type format with smaller dimensions or lookup tables that are normalized separately from fact or associative tables. In this embodiment virtually de-normalized tables can be defined that dynamically and efficiently join the larger fact or associative tables and smaller dimension or lookup tables with the pre-sorted data and match-merge algorithms. In this embodiment virtually de-normalized tables can be defined that dynamically and efficiently join the larger fact tables or associative tables and smaller dimension or lookup tables with the pre-sorted data and match-merge algorithms, while allowing efficient access and filtering from any combination of dimensions or lookup tables.

In another embodiment, dimensions keys from hierarchies of related dimension or lookup tables can be coded together with common hierarchically encoded keys so that levels of data in the smaller dimension or lookup tables can be sorted according to the hierarchies contained within the dimensions or lookups. In addition, the hierarchically encoded keys can be used to order and cluster the larger fact tables or associative tables, either according to a single precedence order or multidimensionally to increase the efficiency of related joins and aggregates. In this embodiment virtually de-normalized tables can be defined that dynamically and efficiently join the larger fact or associative tables and smaller dimension or lookup tables with the pre-sorted data and match-merge algorithms, while allowing efficient access and filtering from any combination of dimensions or lookups.

In another embodiment, designers of relational database engines can implement virtual denormalization into conventional databases and DW systems to be accessed with standard SQL. Analytic queries can join normalized tables via the optimizer or could access virtually de-normalized database tables, thereby circumventing the database optimizer and materializing the tables via internal data structures and algorithms in a manner transparent to the queries. It is even possible to access a combination of the two types of tables, normalized and virtually de-normalized, in the same query.

In another embodiment, designers of NoSQL or key-value databases can implement virtual de-normalization so that NoSQL can more efficiently implement virtual columns. In this case, virtual de-normalization can perform joins and filters within the database to produce virtual column values on demand as if they are stored as a key-value pair in the NoSQL database.

In other embodiments, designers of DW applications can use virtually de-normalized tables to pre-join and support heavily normalized DW designs as advocated by Inmon or dimensional DW designs as advocated by Kimball.

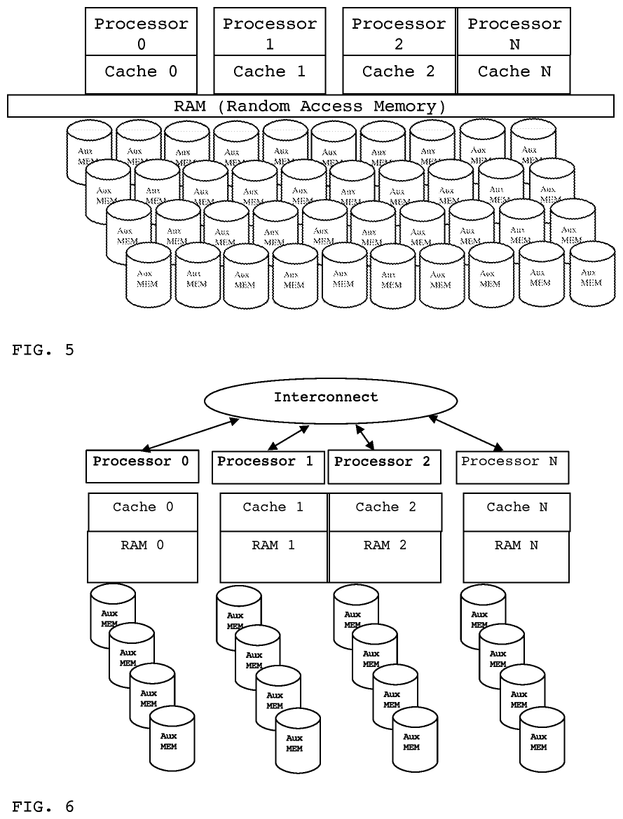

In yet other embodiments, virtually de-normalized DW applications are implemented and executed on small single user personal computers, highly parallel shared memory DW platforms as depicted in FIG. 5, or no-share parallel DW platforms as depicted in FIG. 6.

It is not obvious and counter intuitive, but there are limitations preventing all the above embodiments from being effective without virtually de-normalized tables that have fixed data structures and algorithms in the internals of the database management system that can't be altered by the optimizer on a query by query basis. Practitioners in the art will recognize that the opportunity for better query performance has a high probability of being significantly impeded in a fully optimized database management system, since queries optimized on a query by query basis according to database statistics and heuristic rules within the optimizers are meant to optimize individual queries rather than table join paths irrespectively of queries. Such optimization and associated query performance vary by query, depending on query complexity and structure. Therefore, such optimal and dynamic de-normalization paths are often ignored by optimizers in database management systems or not consistently utilized. In such a fully optimized but unstable environment, practitioners utilize de-normalization via physical materialization to prevent this variation in query plans and observed query performance. Therefore, practitioners in the art opt for reliability at the cost of additional storage, data processing cycles, and often poorer query performance.

### REFERENCES CITED

### U.S. Patent Documents

| U.S. Patent | | | |
|---|---|---|---|
| Number | Date Issued | Inventor | Classification |
| 5,359,724 | October 1994 | Earle | 707/205. |
| 5,369,761 | March 1990 | Conley et al. | 707/E17.007. |
| 5,864,857 | January 1999 | Ohata et al. | 707/100. |
| 5,940,818 | August 1999 | Malloy et al. | 707/2. |
| 5,943,668 | August 1999 | Malloy et al. | 707/3. |
| 6,003,036 | December 1999 | Martin | 707/102. |
| 6,134,541 | October 2000 | Castelli et al. | 707/2. |
| 6,182,060 | January 2001 | Hedgcock et | 707/1. |
| | | al. | |
| 6,460,026 | October 2002 | Pasumansky | 707/1. |
| 6,898,590 | December 2001 | Streifer | 707.999.002 |
| 7,822,776 | October 2010 | Martin | 707/796. |
| 9,020,910 | October 2010 | Bendel et al. | 707/693. |
| PCT/US2013/ | September 2013 | Idicula et al. | |
| 058491 | | | |
| US-9,471,654 | October 2016 | Bradley; | 1/1. |
| Bl | | Robert Scott | |
| US- | May 2006 | Moffat; Alex | 1/1. |
| 2006/0095413 | | | |
| Al | | | |
| US-8,918,388 | December 2014 | Chen; | 707/714. |
| B1 | | Songting | |
| US- | Febraury 2012 | Vossen; | 707/711. |
| 20120030189-Al | | Oliver | |
| US- | October 2013 | Wang; Shan | 707/602. |
| 20130275365-Al | | | |
| US- | December 2008 | Bhattacharya; | 1/1 |
| 20080319958-Al | | Sutirtha | |

### OTHER REFERENCES

Markl, V., et al., “Improving OLAP Performance by Multidimensional Hierarchical Clustering”, Proceedings of Ideas '99 in Montreal Canada, IEEE, 1999.
Markl, V., et al., “The Tetris-Algorithm for Multidimensional Sorted Reading from UB-Trees”, Internal Report, FORWISS München, 1997.
Bertino, E., et al., “Indexing Technique for Queries on Nested Objects”, IEEE Transactions on Knowledge and Data Engineering, pp. 196-214, 1989.
Inmon, Bill, “Building the Data Warehouse”, 1992.
Kimball, Ralph, Ross Margy, “The Data Warehouse Toolkit: The Complete Guide to Dimensional Modeling”, 2002.
Inmon, W. H., Denormalization of Data, SMC XII Proc. of 12th Structured Methods Conf., 6 Aug. 1987.
Martin Rennhackkamp, Tigger Happy, DBMS Online, Server Side, May, 1996

1. In the execution of database queries against one or more preexisting normalized or preexisting de-normalized database tables within one or more database engines where queries are submitted from SQL, application programming interfaces, or user interfaces, where optimizers within said database engines attempt to determine the most efficient query execution paths, and where said database engines execute said queries with the assistance of said optimizers, internal data structures, and internal algorithms in said database engines to execute said queries and return the results of said queries to said SQL, application programming interfaces, or user interfaces of said database engines, an improvement for providing the benefits of speed, efficiency, and simplicity of preexisting, de-normalized database tables without the associated storage and processing costs of said preexisting, de-normalized database tables, said improvement comprising the steps of:
storing and managing the metadata and data content of one or more preexisting normalized or preexisting de-normalized database tables within said database engines;
storing and managing the metadata but not the data content of one or more virtually de-normalized database tables within said database engines;
storing and managing one or more preset algorithms that are internal to said database engines;
storing and managing one or more preset data structures that are internal to said database engines;
utilizing said preset internal algorithms and said preset internal data structures within said database engines and below said SQL, application programming interfaces, and user interfaces to dynamically produce said content of one or more virtually de-normalized database tables within the internals of said database engines;
utilizing execution strategies and paths that are preset when said virtually de-normalized databases are created, irrespective of subsequent queries after the creation of said virtually de-normalized database tables, and without utilizing said optimizers to dynamically join, union, or otherwise combine one or more said normalized or said de-normalized database tables into one or more said virtually de-normalized database tables;
presenting the virtually de-normalized tables as if they were preexisting, de-normalized, and materialized tables for the purposes of any subsequent optimizer operations needed to produce said results of said database queries and
presenting said results of said database queries to said SQL, application programming interfaces, or user interfaces.

2. The method of claim 1, wherein normalized dimension tables or partially normalized dimension tables are virtually joined to fact tables to present the detailed or aggregated data in a virtually de-normalized, dimensional format containing fact tables and dimension tables while still providing direct access to the underlying dimension tables and fact tables at the SQL, application programming interface, or user interface level.

3. The method of claim 1, wherein normalized tables or partially normalized tables are virtually joined to present a virtually de-normalized, semantic or application level view of the data while still providing direct access to the underlying normalized tables or partially normalized tables at the SQL, application programming interface, or user interface level.

4. The method of claim 1, wherein filters for each user or session are used to limit or restrict said virtually de-normalized tables.

5. The method of claim 1, wherein updates can be made to the virtually de-normalized tables and said method updates said normalized or partially normalized tables from which said virtually de-normalized tables are derived.

6. The method of claim 1, wherein said virtually de-normalized tables are implemented on one monolithic computer including processors, input/output devices, and memory.

7. The method of claim 1, wherein said virtually de-normalized tables are implemented on a network of interconnected computers so that said virtually de-normalized tables are derived from said normalized or partially de-normalized tables existing on one or more interconnected computers.

8. The method of claim 1, wherein said SQL, application programming interfaces, or user interfaces to said virtually de-normalized tables are implemented within an application so that said SQL, application programming interfaces, or user interfaces to said virtually de-normalized tables are controlled via said application.

9. The method of claim 1, where said virtually de-normalized tables are implemented in RAM or on secondary storage and work in combination with in-memory databases.

10. The method of claim 1 working in conjunction with a computer hardware apparatus consisting of a network or array of storage media managed separately from a network or array of one or more interconnected computers from claim 1, wherein the method of claim 1 determines the subset of storage media blocks, files, objects, or partitions accessed from said network or array of storage media by said network or array or one of more interconnected computers.

11. In the execution of database queries against one or more preexisting multidimensional, preexisting normalized, or preexisting de-normalized database tables within one or more database engines where queries are submitted from SQL, application programming interfaces, or user interfaces, where optimizers within said database engines attempt to determine the most efficient query execution paths, and where said database engines execute said queries with the assistance of said optimizers, internal data structures, and internal algorithms in said database engines to execute said queries and return the results of said queries to said SQL, application programming interfaces, or user interfaces of said database engines, an improvement for providing the benefits of speed, efficiency, and simplicity of preexisting, de-normalized database tables without the associated storage and processing costs of said preexisting, de-normalized database tables, said improvement comprising the steps of:
storing and managing the metadata and data content of one or more preexisting multidimensional, preexisting normalized, or preexisting de-normalized database tables within said database engines;
storing and managing the metadata but not the data content of one or more virtually de-normalized database tables within said database engines;
storing and managing one or more preset algorithms that are internal to said database engines;
storing and managing one or more preset data structures that are internal to said database engines;
utilizing said preset internal algorithms and said preset internal data structures within said database engines and below said SQL, application programming interfaces, and user interfaces to dynamically produce said content of one or more virtually de-normalized database tables within the internals of said database engines;
utilizing execution strategies and paths that are preset when said virtually de-normalized databases are created, irrespective of subsequent queries after the creation of said virtually de-normalized database tables, and without utilizing said optimizers to dynamically join, union, or otherwise combine one or more said multidimensional or one or more said normalized or said de-normalized database tables into one or more said virtually de-normalized database tables;
presenting the virtually de-normalized tables as if they were preexisting, de-normalized, and materialized tables for the purposes of any subsequent optimizer operations needed to produce said results of said database queries and
presenting said results of said database queries to said SQL, application programming interfaces, or user interfaces.

12. The method of claim 11, wherein normalized dimension tables or partially normalized dimension tables are virtually joined to fact tables to present the detailed or aggregated data in a virtually de-normalized, dimensional format containing fact tables and dimension tables while still providing direct access to the underlying dimension tables and fact tables at the SQL, application programming interface, or user interface level.

13. The method of claim 11, wherein normalized tables or partially normalized tables are virtually joined to present a virtually de-normalized, semantic or application level view of the data while still providing direct access to the underlying normalized tables or partially normalized tables at the SQL, application programming interface, or user interface level.

14. The method of claim 11, wherein filters for each user or session are used to limit or restrict said virtually de-normalized tables.

15. The method of claim 11, wherein updates can be made to the virtually de-normalized tables and said method updates said normalized or partially normalized tables from which said virtually de-normalized tables are derived.

16. The method of claim 11, wherein said virtually de-normalized tables are implemented on one monolithic computer including processors, input/output devices, and memory.

17. The method of claim 11, wherein said virtually de-normalized tables are implemented on a network of interconnected computers so that said virtually de-normalized tables are derived from said normalized or partially de-normalized tables existing on one or more interconnected computers.

18. The method of claim 11, wherein said SQL, application programming interfaces, or user interfaces to said virtually de-normalized tables are implemented within an application so that said SQL, application programming interfaces, or user interfaces to said virtually de-normalized tables are controlled via said application.

19. The method of claim 11, where said virtually de-normalized tables are implemented in RAM or on secondary storage and work in combination with in-memory databases.

20. The method of claim 11 working in conjunction with a computer hardware apparatus consisting of a network or array of storage media managed separately from a network or array of one or more interconnected computers from claim 11, wherein the method of claim 11 determines the subset of storage media blocks, files, objects, or partitions accessed from said network or array of storage media by said network or array or one of more interconnected computers.
